(19) United States
(12) Patent Application Publication
(10) Pub. No.: US 2024/0178495 A1
(43) Pub. Date: May 30, 2024

(54) POWER STORAGE DEVICE

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Tsuyoshi EHARA, Toyota-shi (JP); Yozo UCHIDA, Toyota-shi (JP); Yuki SATO, Toyota-shi (JP); Syoichi TSUCHIYA, Toyota-shi (JP); Masataka ASAI, Toyota-shi (JP); Tsuyoshi ASANO, Toyota-shi (JP); Masahiro UCHIMURA, Toyota-shi (JP); Takashi TAKIMOTO, Kosai-shi (JP); Shigeru MATSUMOTO, Toyohashi-shi (JP); Yasuaki NAGANO, Kosai-shi (JP)

(21) Appl. No.: 18/503,183

(22) Filed: Nov. 7, 2023

(30) Foreign Application Priority Data
Nov. 30, 2022 (JP) 2022-191013

(51) Int. Cl. H01M 50/188; H01M 50/103; H01M 50/176; H01M 50/184; H01M 50/193; H01M 50/588; H01M 50/59

(52) U.S. Cl. CPC H01M 50/188; H01M 50/103; H01M 50/176; H01M 50/184; H01M 50/193; H01M 50/588; H01M 50/59

(57) ABSTRACT

A power storage device includes a case having a metal lid with an insertion hole, a terminal member inserted through the insertion hole, and a resin member insulating between the case and the terminal member. The lid has a surface facing outside, including a ring-shaped hole-surrounding region around the insertion hole, to which the resin member is airtightly firmly fixed, and an outer region contacting the resin member. A two-region consisting of two, the hole-surrounding region and the outer region, has a two-region length at a two-region length ratio of 3.0 or more, which is the ratio of the maximum two-region length to the minimum two-region length, and a seal length of 1.4 or less, which is the ratio of the maximum seal length to the minimum seal length of the hole-surrounding region.

### CROSS-REFERENCE TO RELATED APPLICATIONS

This application is based upon and claims the benefit of priority to Japanese Patent Application No. 2022-191013 filed on Nov. 30, 2022, the entire contents of which are incorporated herein by reference.

### BACKGROUND

### Technical Field

The present disclosure relates to a power storage device.

### Related Art

An example of a power storage device is known as a rectangular battery in which a positive terminal member and a negative terminal member are each fixed to a rectangular parallelepiped box-shaped case via resin members. In such a power storage device, for example, the case includes a bottomed rectangular tube-shaped case body having an opening defined by a rectangular ring-shaped opening end, and a rectangular plate-shaped lid welded to the case body over the entire perimeter of the case body to close the opening. Further, the positive and negative terminal members are individually inserted through a pair of insertion holes provided in the lid to extend from inside to outside of the case. The resin members are each joined to the lid and the corresponding positive or negative terminal member to ensure airtightness while insulating between the lid and the terminal members. One example of the above-mentioned related art is disclosed in Japanese unexamined patent application publication No. 2021-086813.

### SUMMARY

### Technical Problems

A metal case and a resin member joined to this case are different in the thermal expansion coefficient. Accordingly, in a thermal shock test, for example, when a power storage device is exposed to low temperatures, the resin member shrinks more significantly than the case, causing a thermal expansion difference therebetween. Thus, the resin member near an insertion hole of the case may break or fracture. This may cause some failures; for example, airtightness is not maintained and insulation between the case and the terminal member is broken.

### Means of Solving the Problems

To solve the above-mentioned failures, one aspect of the present disclosure provides a power storage device comprising: a case member made of metal and provided with an insertion hole; a terminal member inserted through the insertion hole; an electrode body accommodated in the case member and connected to the terminal member; and a resin member in contact with each of the case member and the terminal member to insulate between the case member and the terminal member, wherein the case member includes a surface facing outside and including a region in contact with the resin member, the region including: a ring-shaped seal region surrounding the insertion hole, to which the resin member is airtightly firmly fixed; and a contact region located outside the seal region in radial directions of the insertion hole, with which the resin member is in contact, a two-region consisting of the seal region and the contact region has a two-region length, which is a total length of the seal and contact regions, at a two-region length ratio of 3.0 or more, which is a ratio of a maximum two-region length to a minimum two-region length, and the seal region has a seal length at a seal length ratio of 1.4 or less, which is a ratio of a maximum seal length to a minimum seal length.

According to the power storage device configured as above, the surface of the case member facing outward includes the ring-shaped seal region around the insertion hole, to which the resin member is airtightly firmly fixed, or anchored, the seal region being configured to have a seal length ratio of 1.4 or less. The rest area other than the ring-shaped seal region forms the contact region, with which the resin member is simply in contact without firmly fixing. With this configuration, on the outwardly-facing surface of the case member, an area around the insertion hole, contacting the resin member, has a small variation in seal length even if having a large variation in two-region length of the two-region consisting of the seal region and the contact region at the two-region length ratio of 3.0 or more. This configuration can therefore prevent an increase in stress due to the thermal expansion difference between the resin member and the metal case member and further prevent concentration of the stress on a certain area in the seal region. Consequently, the above configuration can suppress deterioration of airtightness and breakdown of the insulation between the case member and the terminal member due to temperature changes.

According to the present disclosure, a power storage can be achieved, which less causes failures even when the temperature changes.

### BRIEF DESCRIPTION OF THE DRAWINGS

FIG. 1 is a perspective view of a battery in an embodiment;

FIG. 2 is a cross-sectional view of the battery in the embodiment, taken along a battery height direction and a battery width direction;

FIG. 3 is an enlarged partial top view of the battery in the embodiment, seen from above a lid, around an opening end of a case body and a peripheral edge portion of the lid;

FIG. 4 is an enlarged partial cross-sectional view of the battery in the embodiment, around the opening end of the case body and the peripheral edge portion of the lid, taken along the battery height direction and the battery width direction (A-A in FIG. 3);

FIG. 5 is a flowchart showing a method for producing the battery in the embodiment;

FIG. 6 is a schematic diagram showing that a roughened surface of the lid in the embodiment;

FIG. 7 is a view of a lid assembly formed in a lid-assembly forming step;

FIG. 8 is an explanatory view showing that molten resin is injected into a mold in the lid-assembly forming step;

FIG. 9 is an enlarged partial top view of a battery in a comparative example, seen from above a lid, around an opening end of a case body and a peripheral end portion of the lid; and

FIG. 10 is an enlarged partial cross-sectional view of the battery in the comparative example, around the opening end of the case body and the peripheral portion of the lid, taken along the battery height direction and the battery width direction.

### DETAILED DESCRIPTION OF THE EXEMPLARY EMBODIMENTS

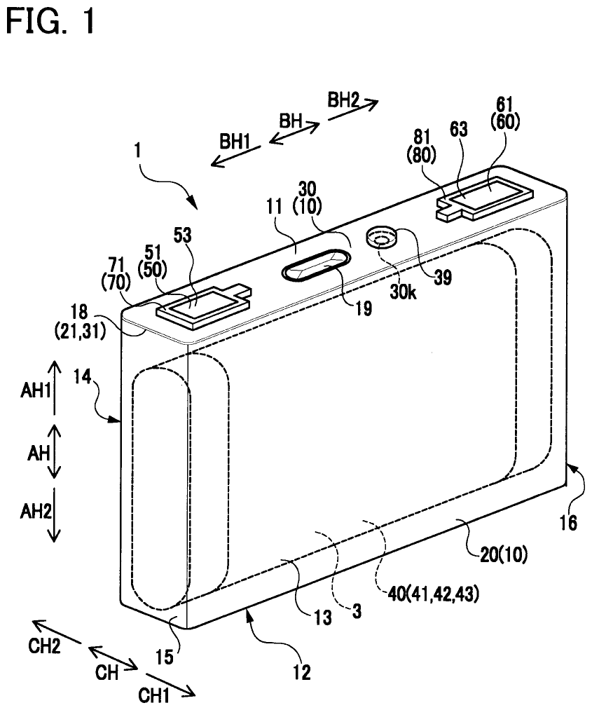

A detailed description of an embodiment will now be given referring to FIGS. 1 to 4. A battery 1 is one example of a power storage device of the present disclosure. In the following description, a battery height direction AH, a battery width direction BH, and a battery thickness direction CH of the battery 1 are defined as indicated by arrows in FIGS. 1 to 4. The battery 1 is a rectangular, i.e., rectangular parallelepiped-shaped, sealed lithium-ion secondary battery which will be installed in a vehicle, such as a hybrid car, a plug-in hybrid car, and an electric car.

### Configuration of Battery

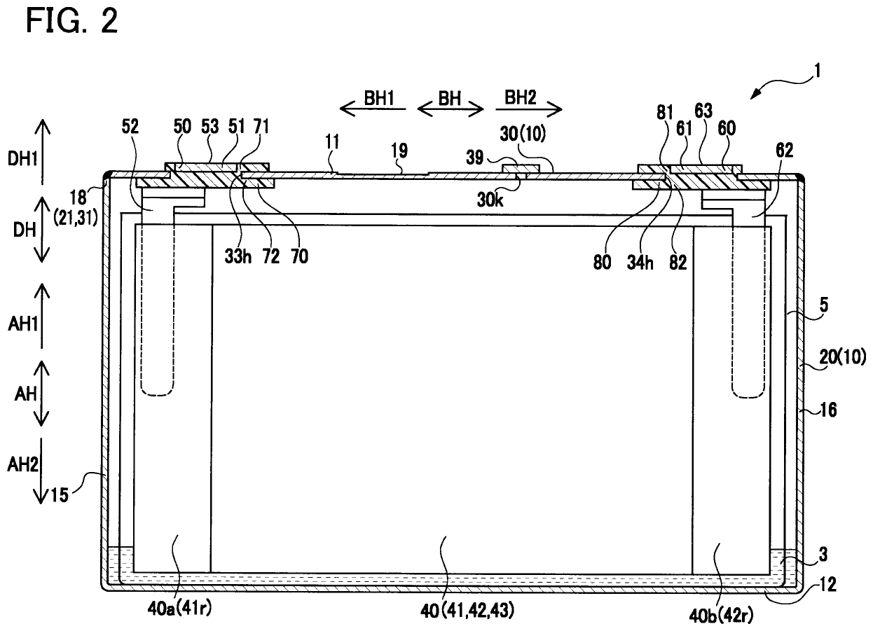

As shown in FIGS. 1 and 2, the battery 1 includes a case 10 having a rectangular parallelepiped shape, made of metal, e.g., aluminum in the present embodiment, and an electrode body 40 accommodated in this case 10. The battery 1 further includes, in an upper part 11 located on the upper side AH1 in the battery height direction AH of the case 10, a positive terminal member 50 supported via a resin member 70 and a negative terminal member 60 supported via a resin member 80. The electrode body 40 is covered with a bag-shaped insulating holder 5 formed of an insulating film. The case 10 contains therein an electrolyte 3, a part of which is impregnated in the electrode body 40 and the rest of which is accumulated on a bottom part 12 located on the lower side AH2 in the battery height direction AH of the case 10.

The case 10 consists of a case body 20 and a lid 30. The case body 20 has a bottomed rectangular tube shape and includes an opening defined by a rectangular ring-shaped opening end 21 on the upper side AH1 in the battery height direction AH. Specifically, the case body 20 forms the bottom part 12 of the case 10, a large-width side part 13 of the case 10 on one side CH1 in the battery thickness direction CH, a large-width side part 14 of the case 10 on the other side CH2 in the battery thickness direction CH, a short-width side part 15 of the case 10 on one side BH1 in the battery width direction BH, and a short-width side part 16 of the case 10 on the other side BH2 in the battery width direction BH. Meanwhile, the lid 30 has a rectangular plate-like shape, forming the upper part 11 of the case 10. The lid 30 closes the opening defined by the opening end 21 of the case body 20 by laser-welding of a peripheral edge portion 31 of the lid 30 over the entire perimeter of the opening end 21 of the case body 20. By this laser-welding, a melt-solidification portion 18 is formed at the boundary between the lid 30 and the case body 20.

The lid 30 is further provided with a safety valve 19 which will break open when the internal pressure of the case 10 exceeds a valve opening pressure. The lid 30 is also provided with a liquid inlet 30k which communicates between the inside and the outside of the case 10, and the liquid inlet 30k is hermetically sealed with a disc-shaped sealing member 39 made of aluminum.

Further, the lid 30 is formed with a rectangular insertion hole 33h penetrating in the lid thickness direction DH, near the end on the one side BH1 in the battery width direction BH, and a rectangular insertion hole 34h penetrating in the lid thickness direction DH, near the end on the other side BH2 in the battery width direction BH. The positive terminal member 50 made of aluminum is inserted through the insertion hole 33h and fixed to the lid 30 via the resin member 70 insulating between the terminal member 50 and the lid 30. The negative terminal member 60 made of copper is inserted through the insertion hole 34h and fixed to the lid 30 via the resin member 80 insulating between the terminal member 60 and the lid 30.

The positive terminal member 50 includes a rectangular plate-shaped outer terminal part 51 located outside the case 10, i.e., the lid 30, and an inner terminal part 52 located inside the case 10 and in the insertion hole 33h of the lid 30. The outer terminal part 51 includes an exposed surface 53 facing outward, i.e., toward the outside DH1 in the lid thickness direction DH of the lid 30. Similarly, the negative terminal member 60 includes a rectangular plate-shaped outer terminal part 61 located outside the lid 30 and an inner terminal part 62 located inside the case 10 and in the insertion hole 34h of the lid 30. This outer terminal part 61 includes an exposed surface 63 facing outward, i.e., toward the outside DH1 in the lid thickness direction DH of the lid 30. The positive inner terminal part 52 is joined and electrically connected to a positive tab 40a of the electrode body 40 inside the case 10. The negative inner terminal part 62 is joined and electrically connected to a negative tab 40b of the electrode body 40 inside the case 10.

The electrode body 40 is a stacked electrode body having a flat rectangular parallelepiped shape, in which a plurality of positive electrode plates 41 and a plurality of negative electrode plates 42, each having a rectangular shape extending in the battery height direction AH and the battery width direction BH, are alternately stacked by interposing a plurality of separators 43 made of porous resin films, one between the electrode plates 41 and 42 in the battery thickness direction CH. Each of the positive electrode plates 41 includes a positive current collecting part 41r extending out on the one side BH1 in the battery width direction BH. The positive current collecting parts 41r overlap each other in the thickness direction, forming the positive tab 40a. This positive tab 40a is connected to the inner terminal part 52 of the positive terminal member 50 as mentioned above. Similarly, each of the negative electrode plates 42 includes a negative current collecting part 42r extending out on the other side BH2 in the battery width direction BH. The negative current collecting parts 42r overlap each other in the thickness direction, forming the negative tab 40b. This negative tab 40b is connected to the inner terminal part 62 of the negative terminal member 60 as mentioned above.

The resin member 70 is in contact with both the lid 30 and the positive terminal member 50 while insulating between the lid 30 and the positive terminal member 50. A part of the resin member 70 is firmly fixed, i.e., bonded, to the lid 30 and the terminal member 50. Similarly, the resin member 80 is in contact with both the lid 30 and the negative terminal member 60 while insulating between the lid 30 and the negative terminal member 60. A part of the resin member 80 is firmly fixed, i.e., bonded, to the lid 30 and the terminal member 60.

The resin member 70 is made of polyphenylene sulfide (PPS) and includes an outer insulating part 71 located outside the case 10, i.e., on the top of the lid 30, and an inner insulating part 72 located inside the case 10 and in the insertion hole 33h of the lid 30. The inner insulating part 72 is continuous to the outer insulating part 71 through the insertion hole 33h of the lid 30. The resin member 80 is also made of PPS and includes an outer insulating part 81 located on the top of the lid 30 and an inner insulating part 82 located inside the case 10 and in the insertion hole 34h of the lid 30. The inner insulating part 82 is continuous to the outer insulating part 81 through the insertion hole 34h of the lid 30.

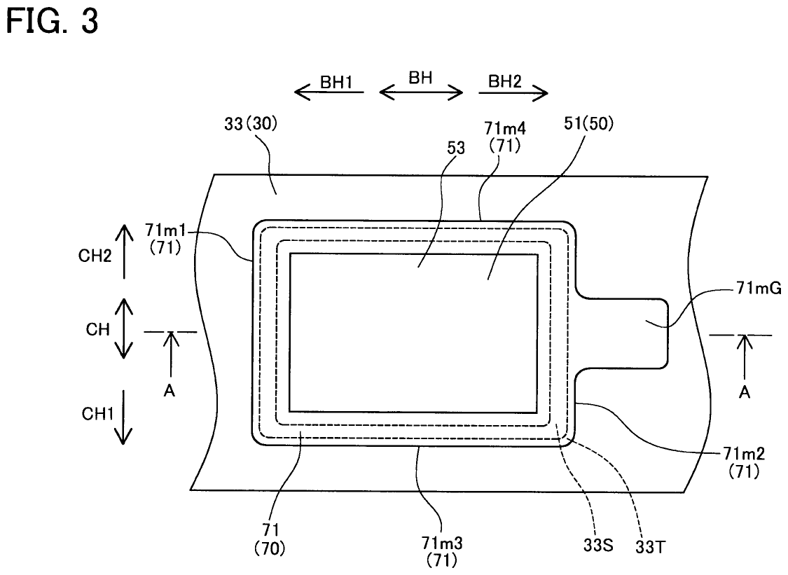

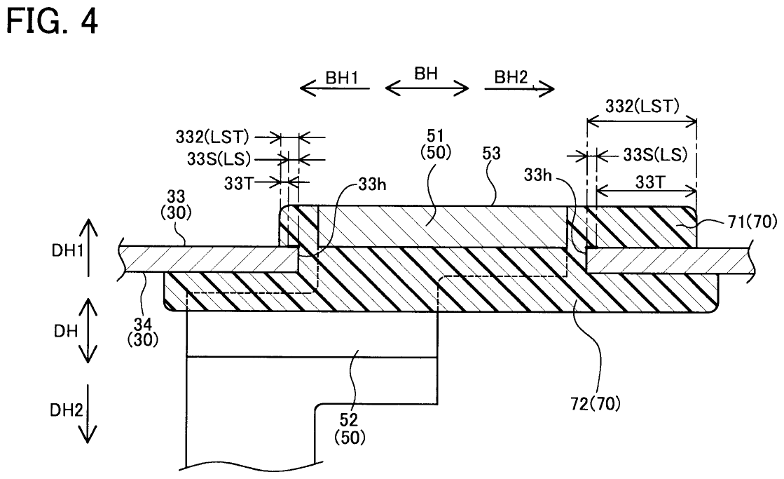

In the resin member 70, the outer insulating part 71 has a frame shape surrounding the outer terminal part 51, as shown in FIGS. 3 and 4, and specifically includes an outer surface portion 71m1 located on the one side BH1 in the battery width direction BH relative to the outer terminal part 51, an outer surface portion 71m2 located on the other side BH2 in the battery width direction BH relative to the outer terminal part 51, an outer surface portion 71m3 located on the one side CH1 in the battery thickness direction CH relative to the outer terminal part 51, and an outer surface portion 71m4 located on the other side CH2 in the battery thickness direction CH relative to the outer terminal part 51. The outer surface portions 71m1, 71m2, 71m3, and 71m4 are each continuous to the inner insulating part 72. It is to be noted that the resin member 80 is identical in structure, except that the orientation is symmetrical with the resin member 70, as shown in FIGS. 1 and 2 and thus its details are omitted herein.

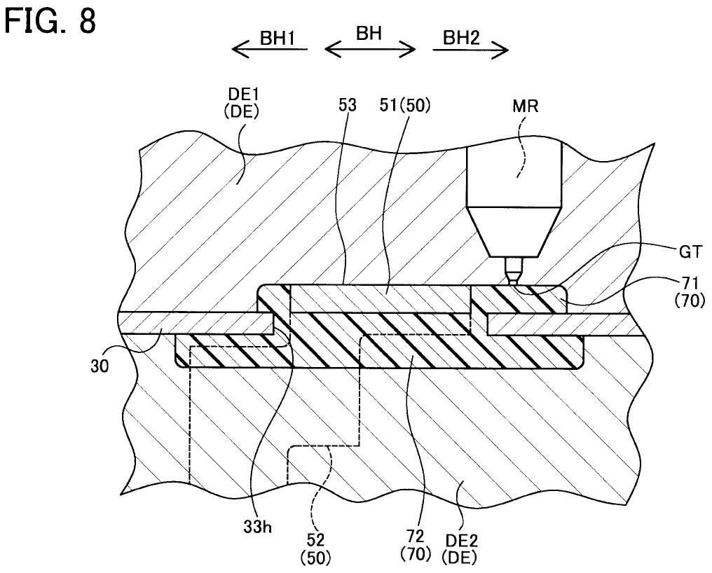

The width of the outer surface portion 71m1, which is the length in the battery width direction BH, the width of the outer surface portion 71m3, which is the length in the battery thickness direction, and the width of the outer surface portion 71m4, which is the length in the battery thickness direction are approximately the same. The outer surface portion 71m2 has a shape, a part of which protrudes on the other side BH2 (i.e., rightward in FIG. 3) in the battery width direction BH, forming a protruding portion 71mG. The resin member 70 is made by insert-molding mentioned later. The protruding portion 71mG is a portion formed facing a gate member GT for injection of molten resin during the insert-molding (see FIG. 8). Accordingly, the width of the outer surface portion 71m2, which is the length in the battery width direction BH, is wider in the area including the protruding portion 71mG than in the other area not including the protruding portion 71mG. The width of this area not including the protruding portion 71mG is approximately the same as the width of the outer surface portion 71m1.

The lid 30 has a surface 33, facing outward, i.e., toward the outside DH1 in the lid thickness direction DH and including regions in contact with the resin member 70, that is, a hole-surrounding region 33S of a rectangular ring shape surrounding the insertion hole 33h and an outer region 33T located outside the hole-surrounding region 33S (i.e., on the far side from the insertion hole 33h) in the radial direction of the insertion hole 33h, that is, in all outward directions (i.e., longitudinal and transverse) of the insertion hole 33h. The length of the hole-surrounding region 33S in the radial directions of the insertion hole 33h is almost uniform over the entire perimeter of the insertion hole 33h. The length of the hole-surrounding region 33S is also referred to as the width of the hole-surrounding region 33S.

In the lid 30, the hole-surrounding region 33S of the surface 33 has been formed with minute (microscopic or nanoscopic) asperities by a surface-roughening treatment. Such surface-roughened region exhibits high tight-contact strength between the metal lid 30 and the resin member 70. Further, the resultant anchor effect enhances the bonding force between the lid 30 and the resin member 70 as compared with an outer region 33T having been not subjected to the surface-roughening treatment. In the surface 33 of the lid 30, the hole-surrounding region 33S with the enhanced bonding force is provided around the insertion hole 33h. This hole-surrounding region 33S allows the resin member 70 to be airtightly secured thereto. The hole-surrounding region 33S is one example of the seal region of the present disclosure.

In contrast, the outer region 33T having not been surface-roughened is in contact with the resin member 70, but has a lower bonding force than the surface-roughened region. In other words, the resin member 70 is not firmly fixed to the outer region 33T and is merely in contact therewith. For example, the protruding portion 71mG of the outer surface portion 71m2 is in contact with the outer region 33T of the surface 33 of the lid 30 without being firmly fixed to the lid 30. The outer region 33T is one example of a contact region of the present disclosure.

The lid 30 further has a surface 34, facing inward, i.e., toward the inside DH2 in the lid thickness direction DH and, as with the surface 33, including regions in contact with the resin member 70, that is, a hole-surrounding region of a rectangular ring shape surrounding the insertion hole 33h and an outer region located outside the hole-surrounding region in the radial direction of the insertion hole 33h, that is, in all outward directions (i.e., longitudinal and transverse) of the insertion hole 33h. This hole-surrounding region of the surface 34 similarly has been surface-roughened, while the outer region of the surface 34 has not been roughened. The width of the hole-surrounding region 33S of the surface 34 is approximately equal to the width of the hole-surrounding region 33S of the surface 33.

The surfaces 33 and 34 of the lid 30, near the insertion hole 34h, each include a rectangular ring-shaped hole-surrounding region that surrounds the insertion hole 34h and is formed with minute asperities by the surface-roughening treatment and with approximately the same width as the hole-surrounding region 33S, as with the surfaces 33 and 34 near the insertion hole 33h, to airtightly firmly fix the lid 30 and the resin member 80.

Similarly, the positive terminal member 50 also includes, on a part of the surface in contact with the resin member 70, a region formed with minute asperities by a surface-roughening treatment. This surface-roughened region is provided in all around the corresponding surface of the terminal member 50 to airtightly firmly fix the positive terminal member 50 and the resin member 70. Similarly, the negative terminal member 60 also includes, on a part of the surface in contact with the resin member 80, a region formed with minute asperities by a surface-roughening treatment to airtightly firmly fix the negative terminal member 60 and the resin member 80.

The regions on the surface 33 of the lid 30, which are in contact with the resin member 70, have the following relationship with each other. Specifically, the seal length LS that is the length (i.e., width) of the hole-surrounding region 33S to which the resin member 70 is firmly fixed, i.e., the length in the radial direction of the insertion hole 33h, has a seal length ratio, which is the ratio of maximum seal length LSmax to the minimum seal length LSmin, of 1.4 or less, preferably 1.2 or less. In other words, the length (i.e., width) of the hole-surrounding region 33S is almost uniform over the entire perimeter of the insertion hole 33h. This seal length is defined by the minimum length of a straight line extending outward in the radial direction of the insertion hole 33h through only the hole-surrounding region 33S, that is, from a point on the inner perimetric edge of the hole-surrounding region 33S, i.e., the inner edge located inside in the radial direction of the insertion hole 33h, to a point on the outer perimetric edge of the hole-surrounding region 33S, i.e., the outer edge located outside in the radial direction of the insertion hole 33h.

The protruding portion 71mG is a part of the outer surface portion 71m2 as mentioned above. Thus, of the regions on the surface 33 of the lid 30, contacting the resin member 70, the outer region 33T has a larger width in the area contacting the protruding portion 71mG than other areas. In the other areas, the outer region 33T has a smaller width that is almost uniform over those other areas. Therefore, the two-region length LST that is the length of a two-region 332 consisting of two regions, i.e., the hole-surrounding region 33S and the outer region 33T, is longer in the area contacting the protruding portion 71mG than the two-region length LST of the other areas of the two-region 332. This two-region length LST is defined by the maximum length of a straight line extending outward in the radial direction of the insertion hole 33h, i.e., in all outward extending directions (i.e., longitudinal and transverse) of the hole-surrounding region 33S, through only the two-region 332 from a point on the inner perimetric edge of the hole-surrounding region 33S to a point on the outer perimetric edge of the outer region 33T.

In the present embodiment, concretely, the two-region length LST of the two-region 332 consisting of the two, hole-surrounding region 33S and outer region 33T, has a two-region length ratio of 3.0 or more, which is the ratio of the maximum two-region length LSTmax to the minimum two-region length LSTmin. The width of the two-region consisting of the hole-surrounding region 33S and the outer region 33T, that is, the length of the outer insulating part 71 in the radial direction of the insertion hole 33h, widely varies over the entire perimeter of the insertion hole 33h, but the width of the hole-surrounding region 33S, to which the outer insulating part 71 is firmly fixed, on the surface 33 of the lid 30 is almost uniform over the entire perimeter of the insertion hole 33h.

### Production of Battery

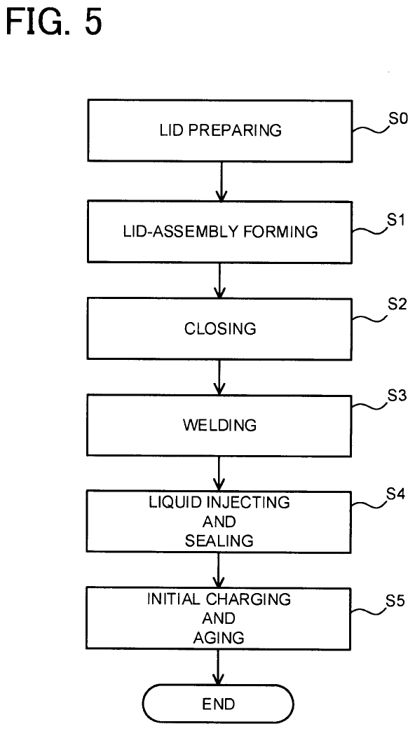

Next, the method for producing the battery 1 described above will be described below, referring to a flowchart in FIG. 5. In a lid-member preparing step S0, the lid 30 is prepared first. The lid 30 is produced in advance for example by pressing an aluminum plate into a predetermined shape with the liquid inlet 30k, insertion holes 33h and 34h, and safety valve 19. The positive terminal member 50 is produced for example by pressing an aluminum plate and the negative terminal member 60 is produced for example by pressing a copper plate.

Then, the lid 30 produced by press work as above is subjected to a surface-roughening treatment in which a part of the surface 33 of the lid 30, corresponding to the hole-surrounding region 33S and others, is roughened. This surface-roughening treatment is performed as below on each target region, such as the hole-surrounding region 33S of the lid 30. Specifically, a laser beam is irradiated to a first site of the target region for the surface-roughening treatment, thereby melting this first site. As the metal lid 30 melts, metal particles are generated from metal vapor or plasma released into the atmosphere, and these particles are deposited again on and around the first site.

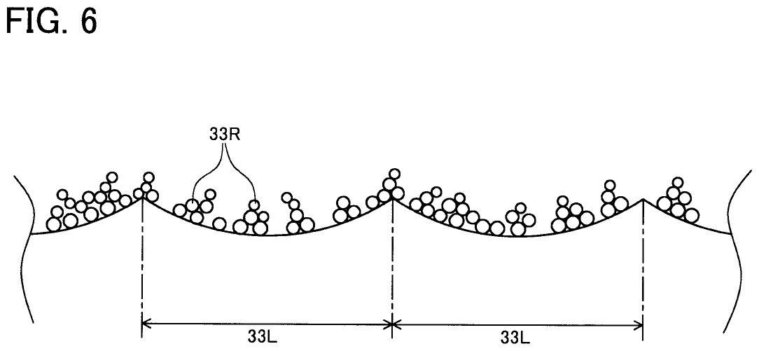

Then, a laser beam is irradiated to a second site adjacent to the first site, thereby melting the second site, causing metal particles to be deposited again on the second site as in the first site. When the laser beam is irradiated over the entire target region for the surface-roughening treatment as above, as shown in FIG. 6, a plurality of recesses 33L are formed by the laser beam and a plurality of protrusions 33R are formed by deposition of the metal particles on the target region. Thus, the target region is wholly formed with minute asperities of the order of nanometers (nm) on the surface, forming the hole-surrounding region 33S on the surface 33 of the lid 30, for example. The same surface-roughening treatment is also applied to a predetermined region of each of the terminal members 50 and 60.

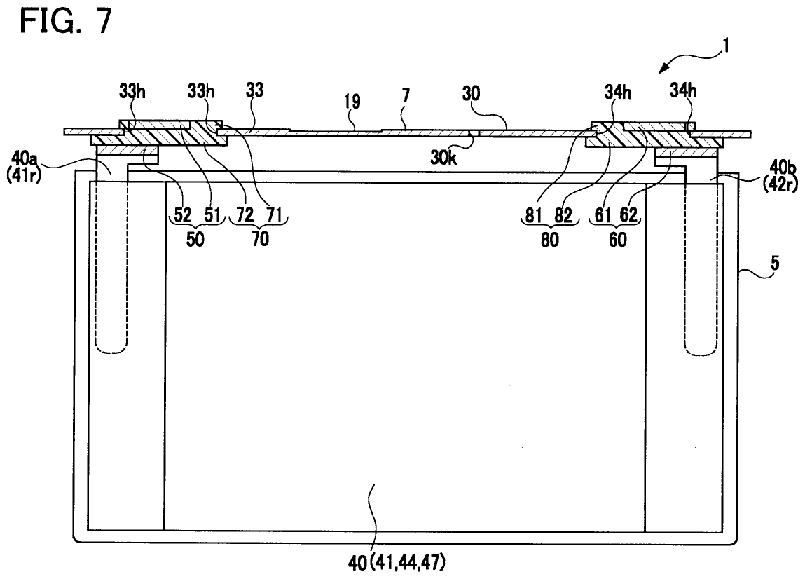

In a lid-assembly forming step S1, a lid assembly 7 as shown in FIG. 7 is formed. This lid assembly 7 is an integral unit including several parts of the battery 1, i.e., the lid 30 having been subjected to the surface-roughening treatment, the terminal members 50 and 60 having been subjected to the surface-roughening treatment, the resin members 70 and 80, and the electrode body 40 enclosed by the insulating holder 5. In the lid-assembly forming step S1, the lid 30 and the terminal members 50 and 60 are prepared, and the resin members 70 and 80 are made by insert-molding, so that the terminal members 50 and 60 are integrated to the lid 30 via the resin members 70 and 80 respectively.

Concretely, in the lid-assembly forming step S1 using a mold DE having an upper mold DE1 and a lower mold DE2, the lid 30 is set at a predetermined position in the lower mold DE2 as shown in FIG. 8. Subsequently, the terminal members 50 and 60 are respectively inserted in the insertion holes 33h and 34h of the lid 30 set in the lower mold DE2. The upper mold DE1 is then moved down onto the lower mold DE2 to close the mold DE. Further, molten resin MR is injected into the mold DE and then cooled, forming the resin members 70 and 80. After that, the upper mold DE1 is moved upward, and a composite molded product in which the lid 30 is integrated with the terminal members 50 and 60 via the resin members 70 and 80 respectively is taken out of the lower mold DE2.

In the present embodiment, since the resin member 70 is formed by insert-molding, this resin member 70 includes a region which is continuous with the gate member GT at the stage where the molten resin MR is injected into the mold DE. This region connecting to the gate member GT forms the protruding portion 71mG of the outer surface portion 71m2 of the outer insulating part 71 of the resin member 70.

Next, the electrode body 40 is prepared, in which the positive electrode plates 41, negative electrode plates 42, and separators 43 are stacked. To the positive tab 40a and the negative tab 40b of the electrode body 40, the inner terminal part 52 of the terminal member 50 and the inner terminal part 62 of the terminal member 60 of the composite molded product are respectively connected by welding. Then, this electrode body 40 is enclosed in the pouched insulating holder 5. Thus, the lid assembly 7 consisting of the lid 30, terminal members 50 and 60, resin members 70 and 80, electrode body 40, and insulating holder 5 is formed.

In a closing step S2, the case body 20 is prepared, the electrode body 40 covered by the insulating holder 5 of the lid assembly 7 formed in the lid-assembly forming step S1 is inserted into the case body 20, and the lid 30 is placed with the peripheral edge portion 31 closing the opening end 21 of the case body 20.

In a welding step S3, a laser beam is applied to the opening end 21 of the case body 20 and the peripheral edge portion 31 of the lid 30, from the outside DH1 in the lid thickness direction DH of the lid 30, i.e., from the upper side AH1 in the battery height direction AH, forming a melt-solidification portion 18 over the entire perimeter of the opening end 21 and the peripheral edge portion 31. Thus, the case 10 is completed.

In a liquid injecting and sealing step S4, the electrolyte 3 is injected into the case 10 through the liquid inlet 30k to impregnate the electrode body 40 with the electrolyte 3. Thereafter, the liquid inlet 30k is covered with the closing member 39 from the outside, and the closing member 39 is welded, over its entire circumference, to the lid 30, thereby hermetically sealing between the closing member 39 and lid 30.

In an initial charging and aging step S5, a charging device (not shown) is connected to the battery 1 and initially charges the battery 1. Then, the initially charged battery 1 is allowed to stand for a predetermined time to age. Thus, the battery 1 is completed.

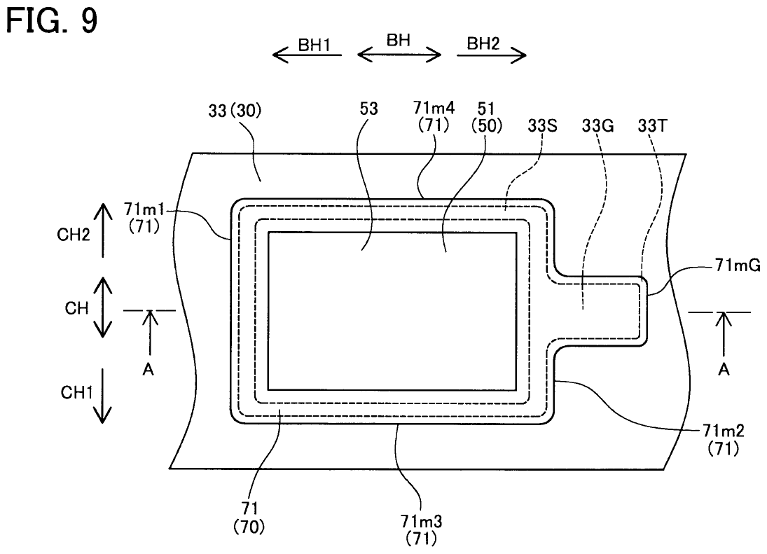

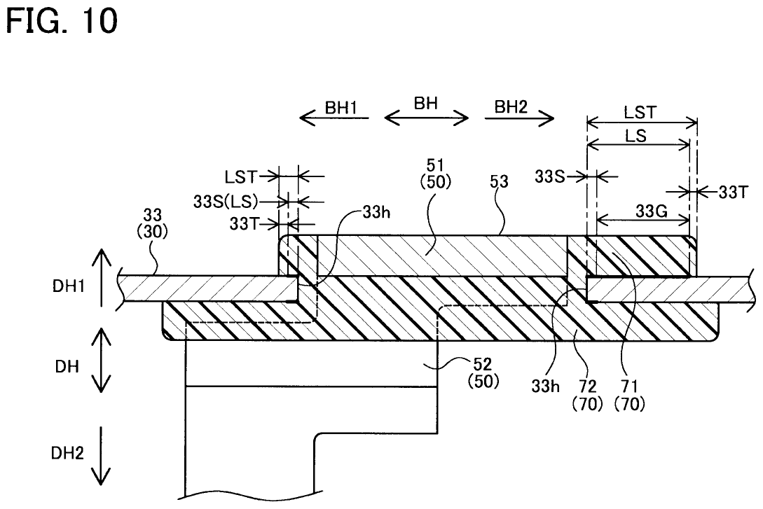

In integrating the resin member 70 and the lid 30 by insert-molding as described above, the outer insulating part 71 to be formed in contact with the surface 33 of the lid 30 has to include the protruding portion 71mG, to which the gate member GT is directed. To strongly fix the resin member 70 to the lid 30 to enhance airtight strength between resin member 70 and the lid 30, it is conceivable to widen the seal region, which is a firmly-fixing region, by applying the surface-roughening treatment over the entire region, of the surface 33 of the lid 30, with which the resin member 70 is to contact. For example, for the battery 1, it is also conceivable to apply the surface-roughening treatment even onto a gate facing region 33G on the surface 33 of the lid 30, which faces the gate member GT when the molten resin MR is injected during the insert-molding, and which contacts the molded protruding portion 71mG, as shown in FIGS. 9 and 10. This gate facing region 33G corresponds to one example of a resin injected area of the present disclosure.

However, the lid 30 made of metal, e.g., aluminum for the battery 1 in the present embodiment, differs in thermal expansion coefficient from the resin member 70 made of resin, e.g., PPS for the battery 1 in the present embodiment. Accordingly, when the seal region includes a wider part, if the thermal expansion difference (i.e., the thermal contraction difference) occurs in an environment with large temperature changes, for example, in a thermal shock test, the wider part may be subjected to the the stress, especially, the tensile stress in the radial direction of the insertion hole 33h. This may cause breakage of the resin member 70 near the hole-surrounding region 33S. If such a broken site in the resin member 70 is merely far from the insertion hole 33h, the airtightness and the insulation are less affected. In contrast, if the broken site is near the insertion hole 33h, it is highly likely that the airtightness is deteriorated or the insulation is broken.

In contrast, in the battery 1 in the present embodiment, the lid 30 is configured such that the surface 33 facing outside DH1 in the lid thickness direction DH includes the ring-shaped hole-surrounding region 33S surrounding the insertion hole 33h, to which the resin member 70 is airtightly firmly fixed, and the seal length LS that is the length of the hole-surrounding region 33S has a seal length ratio of 1.4 or less, expressed by LSmax/LSmin, where LSmax is the maximum seal length and LSmin is the minimum seal length. The surface 33 also includes the outer region 33T, other than the annular hole-surrounding region 33S, the outer region 33T only allowing the resin member 70 to make contact without being firmly fixed. With this configuration, on the surface 33 of the lid 30, the region around the insertion hole 33h and contacting the resin member 70 even has a large variation in two-region length LST, e.g., with the two-region length ratio of the two-region 332 consisting of the hole-surrounding region 33S and the outer region 33T (i.e., the maximum two-region length LSTmax/the minimum two-region length LSTmin) being 3.0 or more, but has a small variation in the seal length LS. Thus, the stress due to the thermal expansion difference between the resin member 70 and the metal lid 30 is less likely to increase, and further the stress is unlikely to concentrate on a specific position on the hole-surrounding region 33S. This can prevent deterioration of airtightness and breakdown of the insulation caused by temperature changes.

The foregoing embodiments are mere examples and give no limitation to the present disclosure. The present disclosure may be embodied in other specific forms without departing from the essential characteristics thereof. For example, the electrode body accommodated in the case 10 is shown as the stacked electrode body in the foregoing embodiment, but it may be a flat wound electrode body. As another alternative, a plurality of electrode bodies may be accommodated together in a single case.

In the foregoing embodiment, the present disclosure is applied to the lithium ion battery. However, the present disclosure is applicable to any general power storage devices, such as a nickel-metal hydride battery or a nickel-cadmium battery.

In the foregoing embodiment, the surface-roughening treatment is performed on each of a lid and terminal members by irradiation of a laser beam to form metal deposits (anchors) on the metal surface. As an alternative, any general surface-roughening treatments may be adopted. For example, a surface-roughening treatment using an acid-based etching agent may be adopted to form pores in the metal surface.

In the foregoing embodiment, the hole-surrounding region 33S on the surface 33 of the lid 30 exists outside, adjacent to, the insertion hole 33h in the radial direction, but it is not necessarily located just adjacent to the insertion hole 33h and may be located apart from the insertion hole 33h so that a region not subjected to the surface-roughening treatment is provided between the insertion hole 33h and the inner perimetric edge of the hole-surrounding region 33S.

In the foregoing embodiment, in the resin member 70, the outer surface portion 71m2 is formed in the non-uniform shape including the protruding portion 71mG. However, the shape of the outer surface portion 71m2 is not limited thereto, and may be entirely rectangular for example including an area which is located facing the gate member GT.

### REFERENCE SIGNS LIST

1 Battery (Power storage device)
10 Case
20 Case body
30 Lid
33h Insertion hole
33S Hole-surrounding region (Seal region)
33T Outer region (Contact region)
50 Terminal member
70 Resin member

What is claimed is:

1. A power storage device comprising:
a case member made of metal and provided with an insertion hole;
a terminal member inserted through the insertion hole;
an electrode body accommodated in the case member and connected to the terminal member; and
a resin member in contact with each of the case member and the terminal member to insulate between the case member and the terminal member,
wherein the case member includes a surface facing outside and including a region in contact with the resin member, the region including:
a ring-shaped seal region surrounding the insertion hole, to which the resin member is airtightly firmly fixed; and
a contact region located outside the seal region in radial directions of the insertion hole, with which the resin member is in contact,
a two-region consisting of the seal region and the contact region has a two-region length, which is a total length of the seal and contact regions, at a two-region length ratio of 3.0 or more, which is a ratio of a maximum two-region length to a minimum two-region length, and
the seal region has a seal length at a seal length ratio of 1.4 or less, which is a ratio of a maximum seal length to a minimum seal length.

2. The power storage device according to claim 1, wherein the seal length ratio of the seal length is 1.2 or less.

3. The power storage device according to claim 1, wherein the contact region includes an area having the maximum two-region length, and this area includes a resin injected area made of resin injected in insert-molding.

4. The power storage device according to claim 2, wherein the contact region includes an area having the maximum two-region length, and this area includes a resin injected area made of resin injected in insert-molding.

5. The power storage device according to claim 1, wherein the seal region is located on the surface facing outside the case member and has been subjected to a surface-roughening treatment.

6. The power storage device according to claim 2, wherein the seal region is located on the surface facing outside the case member and has been subjected to a surface-roughening treatment.

7. The power storage device according to claim 3, wherein the seal region is located on the surface facing outside the case member and has been subjected to a surface-roughening treatment.

8. The power storage device according to claim 4, wherein the seal region is located on the surface facing outside the case member and has been subjected to a surface-roughening treatment.
